(19) United States
(12) Patent Application Publication
(10) Pub. No.: US 2014/0102280 A1
(43) Pub. Date: Apr. 17, 2014

(54) Adjustable Stress-A-Way Bridge

(71) Applicant: Jack Rogers, Hillsboro, OH (US)

(72) Inventor: Jack Rogers, Hillsboro, OH (US)

(21) Appl. No.: 13/653,404

(22) Filed: Oct. 16, 2012

(51) Int. Cl. G10D 3/04

(52) U.S. Cl. CPC G10D 3/04
USPC 84/298

(57) ABSTRACT

For over 150 years, conventional acoustic guitar designs have anchored the strings on a bridge attached to the guitar face; passing over a saddle; notched to align the strings over the fingerboard; and terminating at the tuning keys. The strain on the bridge and entire guitar face top over time eventually causes the thin guitar face top to warp. This phenomenon negatively impacts the quality of the instrument.

The current patent, a bridge for stringed instruments (No. 6372971) was designed to eliminate surface warping to the guitar face of the instrument by distributing the load from the strings transversely across the guitar face. The principle of this feature, added to the current aforementioned patent, allows the user to raise and/or lower the strings (for the ease and comfort of the user) relative to the fingerboard without affecting the tuned strings or requiring a major operation to modify the saddle.

While the invention is applicable to most stringed instruments, the included drawings represent acoustic guitar applications.

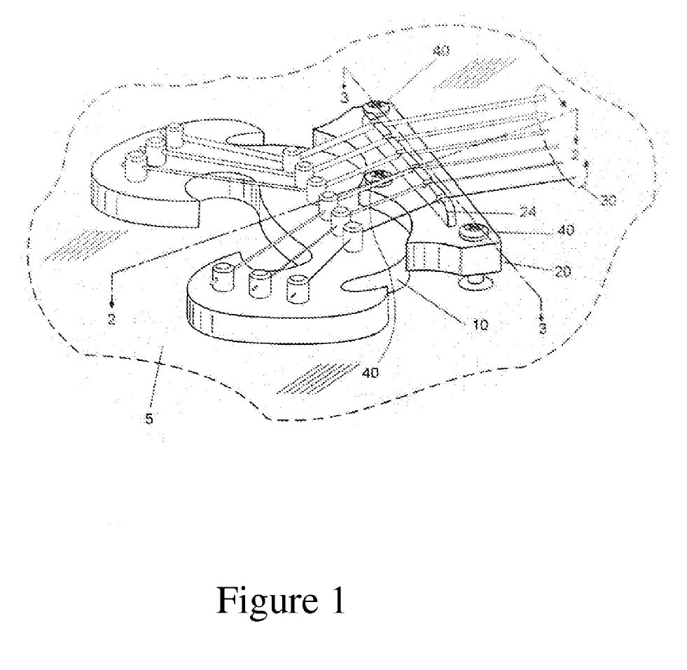

FIG. 1 is a perspective view of the preferred embodiment of the invention and a perspective view showing the riser plate and saddle in a raised position.

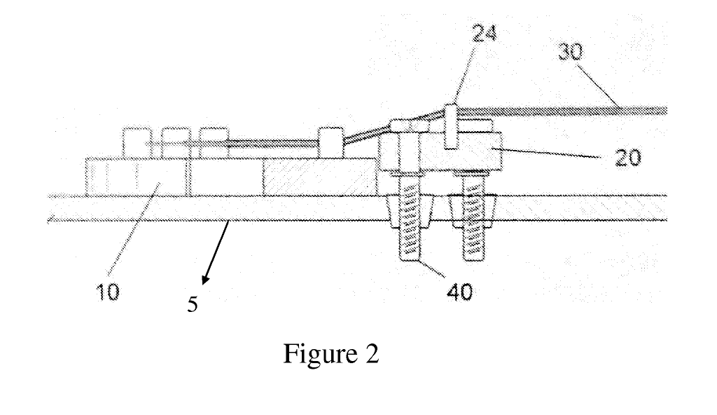

FIG. 2 is a cross sectional side view of the preferred embodiment of the invention.

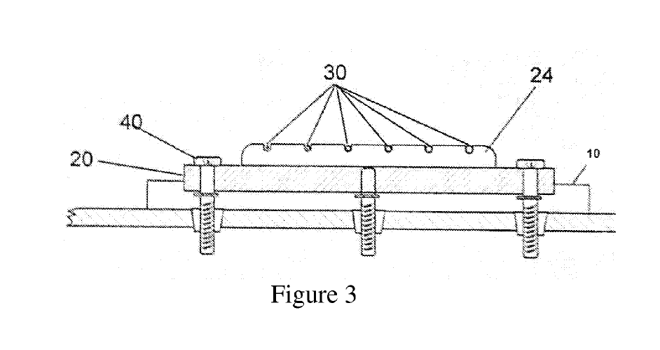

FIG. 3 is a cross sectional end view of the preferred embodiment of the invention.

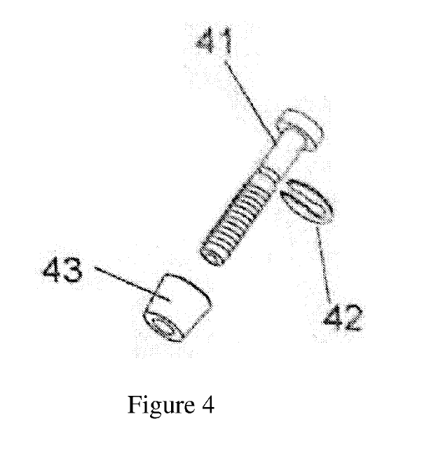

FIG. 4 is the mounting screw assembly (40).

The aforementioned included figures are based on prototype models of the invention. They are made of wood and depict a workable design. Other materials and manufacturing processes may be selected and visual modifications will remain apparent to those skilled in the art of instrument design and building. However, the principles of the present invention are established within the definition of the Utility patent(s).

FIG. 1

A bridge (10) is attached to the top surface of the guitar face top (5) and is strung with six strings (30). Abutting the bridge, a riser plate (20) is installed utilizing three adjustable mounting screw assemblies (40). Above the riser plate is a saddle (24) with notches which separate the strings. The riser plate is free to allow strings to be raised or lowered by adjusting the mounting screws. A more detailed depiction is illustrated in FIG. 4.

FIG. 2

This is a cross section side view which shows the riser plate (20) and strings (30) in a raised position to accommodate the user.

FIG. 3

This is a cross sectional end view as seen from the top of the fingerboard.

FIG. 4

This is an exploded view of the mounting screw assembly including screw (41), the snap washer (42), the tapered nut (43a), and the T-Nut (43b). This figure also shows how the strings may be lowered or raised to accommodate the taste of the user.

I claim:

1. To have engineered an acoustic bridge for stringed instruments that allows the user to raise/lower the strings (for ease and comfort of the user) relative to the fingerboard without requiring a major modification of the saddle.

2. This bridge also equally distributes the load exerted by the tightened strings across the top/face of the instrument thus eliminating warping of the neck and instrument top.

3. The bridge makes raising and lowering the strings simply a matter of tightening or loosening three adjustable mounting screws located on a riser plate abutting the bridge.
